(19) United States
(12) Patent Application Publication
(10) Pub. No.: US 2005/0076239 A1
(43) Pub. Date: Apr. 7, 2005

(54) Configurable password maintenance

(75) Inventors: Victoria A. Locke, Fishkill, NY (US); James A. Martin JR., Endicott, NY (US); Renee C. Mullins, Rochester, MN (US); Douglas G. Murray, Johnson City, NY (US)

Correspondence Address: Steven Fischman, Esq.;Scully, Scott, Murphy & Presser, 400 Garden City Plaza, Garden City, NY, 11530, US

(73) Assignee: International Business Machines Corporation, Armonk, NY (US)

(21) Appl. No.: 10/680,859

(22) Filed: Oct. 7, 2003

(51) Int. Cl. H04L 9/00

(52) U.S. Cl. 713/201

(57) ABSTRACT

Disclosed are a tool and method for maintaining passwords. The tool comprises storage for a plurality of current passwords for a plurality of respective applications, and means for displaying a reminder to change one or more of said passwords. The tool further comprises a script for simulating keystroke entries, or running an executable program, to automatically perform a password change in said respective applications for said current passwords of said reminder. These applications may be, for example, workstation applications, legacy host applications, server applications, and networked applications.

### BACKGROUND OF THE INVENTION

1. Field of the Invention

This invention generally relates to password maintenance. More specifically, the invention relates to a tool and to a method to maintain passwords for a plurality of applications.

2. Background Art

Many remotely accessible computer systems require user authentication. The user, commonly operating a client system, must be registered with the remote system and must type in his or her user ID and a password for that remote system every time it is accessed.

One problem presented by the need for user authentication is that if the user accesses multiple remote systems, the user must remember numerous passwords and user IDs. Many users confronted with this problem will often try to use the same password for each remote system or write down a list of passwords.

Both of these makeshift solutions compromise security. If the same password is used for each remote system, a system administrator of one remote system will be able to obtain passwords usable to access other remote systems. A written list of passwords is an obvious breach of security in that anyone with access to the list will be able to access any of the remote systems.

Another problem with password protected access is that if a user's password becomes, or may have become, known to others, it may be necessary for the user to change his or her password. This may be a time consuming or inconvenient task, especially if multiple passwords or multiple remote applications are involved.

The problem of authenticating a user to a plurality of remote systems has become particularly apparent in light of the proliferation of limited access sites on the World Wide Web (WWW). Before accessing a site, the user is presented with an authentication form generated by his or her WWW browser requesting a user ID and password. The user must register separately with each such site and maintain multiple passwords. Furthermore, when navigating through the WWW, he or she is frequently interrupted by authentication messages requesting a user ID and password.

### SUMMARY OF THE INVENTION

An object of this invention is to provide a tool for maintaining passwords

Another object of the invention is to provide an application that allows a person to define, in a secure way, a multitude of passwords as well as what actions they need to perform to initiate a password change.

These and other objects are attained with a tool and met-hod for maintaining passwords. The tool comprises storage for a plurality of current passwords for a plurality of respective applications, and means for displaying a reminder to change one or more of said passwords. The tool further comprises a script for simulating keystroke entries, or running an executable program, to automatically perform a password change in said respective applications for said current passwords of said reminder. These applications may be, for example, workstation applications, legacy host applications, server applications, and networked applications.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates an end-user computing environment in which the present invention may be implemented.

FIG. 2 shows a display of a typical array of passwords that may be managed by the invention.

FIGS. 3-6 show screens that may be displayed in the implementation of this invention.

### DETAILED DESCRIPTION OF THE PREFERRED EMBODIMENTS

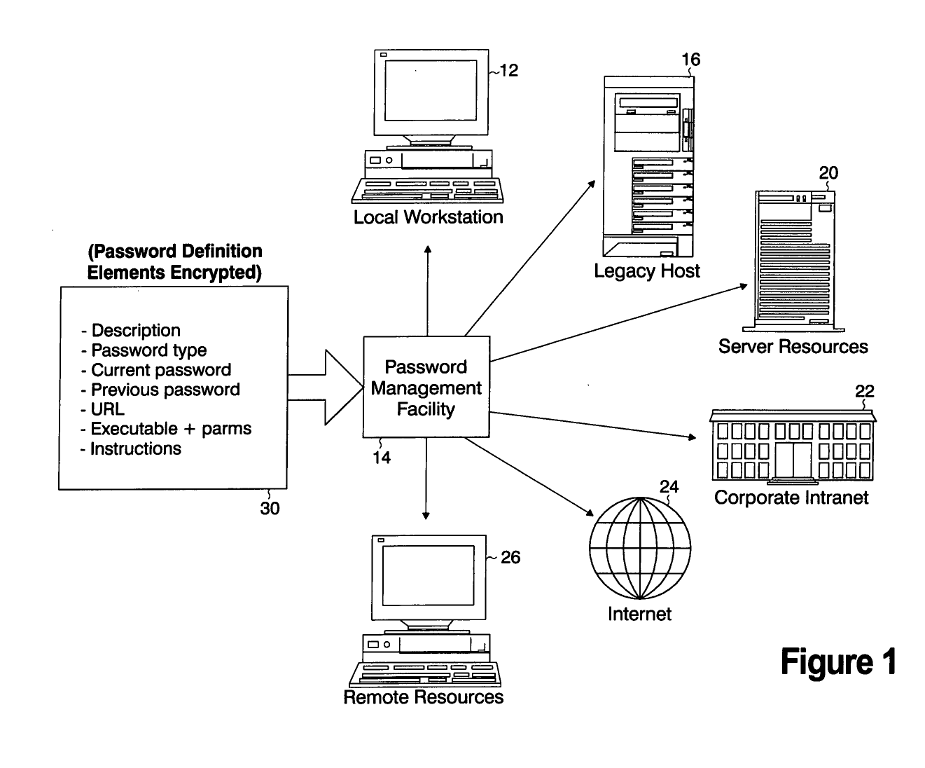

FIG. 1 illustrates an end-user computing environment with which the present invention may be used. More specifically, FIG. 1 shows a user computer or workstation 12, password management facility 14, and a plurality of icons representing remote applications. These icons, for example, represent applications on a legacy host system 16, applications available on server resources 20, applications available via a corporate intranet 22 or via the Internet 24, and applications that can be accessed via other remote resources 26. FIG. 1 also graphically represents, at 30, information that may be held in or used by facility 14.

Generally, a person uses computer 12 to connect the computer to the remote applications, and many of these applications require that the user provide a password in order to obtain access to the application. Management facility 14 is provided to hold those passwords and to hold executable script, or other code, that can be invoked or activated to change those passwords.

More specifically, client 12 connects to a remote application by transmitting a connection message. Upon receiving this message, the remote application, or more commonly a manager thereof, invokes a security process. This security process receives a user ID and a password combination from the connection message transmitted by the client. A valid user ID and, often, a user account are associated with a password, all of which have been previously established with the application manager.

When the security process receives the user ID and password combination transmitted by the client, the security process then determines whether the combination of the user ID and password is valid. If the combination is valid, the security process returns a message to the application manager indicating that the combination is valid, and the application manager then permits the client to have access to the application.

From time-to-time, the password associated with a user ID may be, or may need to be, changed. For instance, the security and password mechanisms of a remote application may occasionally require changing the password, or the client may want to change the password.

With prior art systems, in order to make a password change, the client transmits a change password message to a remote application or, more commonly, to the manger thereof. This message may include not only a proposed new password, but also additional information that is needed by the remote application to process the change request. After receiving this change password message, the application manager invokes the security process, which in turn invokes a change password routine. This routine, which may require that several criteria be met before a password can be changed, determines whether the password change is allowable. If that change is allowable, the security process effects that password change and transmits a message to the client indicating that this change has been made.

These prior art routines for changing passwords can become time consuming and inconvenient, especially if a client wants to change several passwords at the same time.

The present invention addresses this issue by providing password management facility 14 to manage passwords and password changes. Generally, facility 14 includes a list of passwords for associated, remote applications; and for each password, the facility includes script or code for changing the password.

Preferably, facility 14 includes additional information about the passwords and the associated applications. For example, and as represent in FIG. 1, for each of a group of applications, facility 14 may include a description of the application, a description of the password type, the current and the previous passwords, the URL for the application, executable code and parameters needed to change the password, and readable instructions for changing the password.

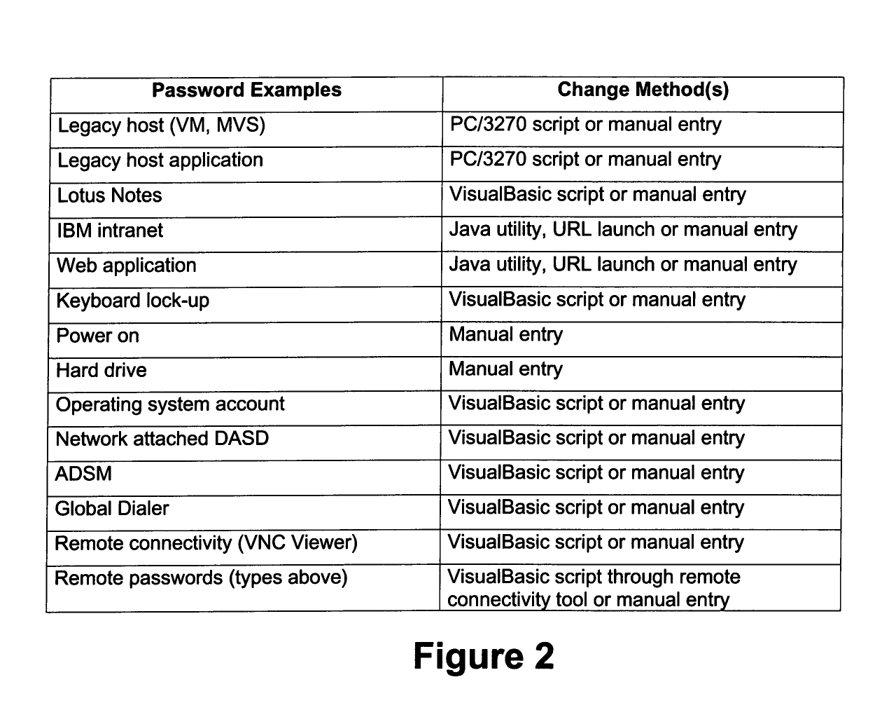

To change one or more of the passwords listed in facility 14, the user accesses that facility; and when this is done, a list of the passwords is displayed. This display may show additional information about the passwords and the related remote applications. For example, as illustrated in FIG. 2, facility 14 may display a brief description of or reference to the remote applications, and a brief description of or reference to the procedure employed to change the password.

Also, preferably, facility 14, when invoked, displays a graphical user interface that, in turn, may be used to invoke or activate the script needed to change the passwords. For example, a button may be shown next to or adjacent to each password; and the client may invoke the script to change a particular password by moving a cursor or pointer onto the button and transmitting an input signal, such as by clicking a mouse connected to the client computer. Other procedures for invoking the script or code to change a password will be apparent to those skilled in the art and may be used in the practice of the invention.

Various user prompts may also be displayed to obtain information from the user when a script or code is invoked to change a password. For instance, these prompts may be used to get a new password from the user, or to obtain other data needed to change the password.

Preferably, facility 14 itself is password protected, and, in addition, some or all of the data stored in the facility may be encrypted. Thus, a user needs a specific password to obtain access to the facility, and the facility includes, or is otherwise used with, a manager application or security process to determine if a particular user is to be given access to the information and scripts in the facility. Also, facility 14 may have multiple levels or degrees of access, so that different users may have different degrees or types of access to the facility.

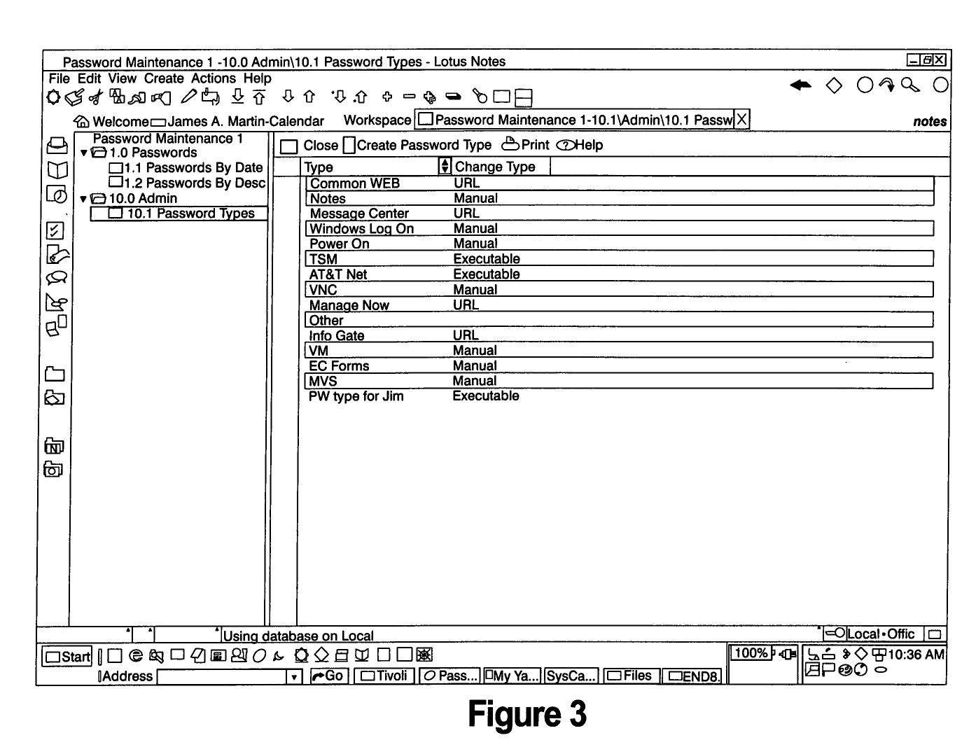

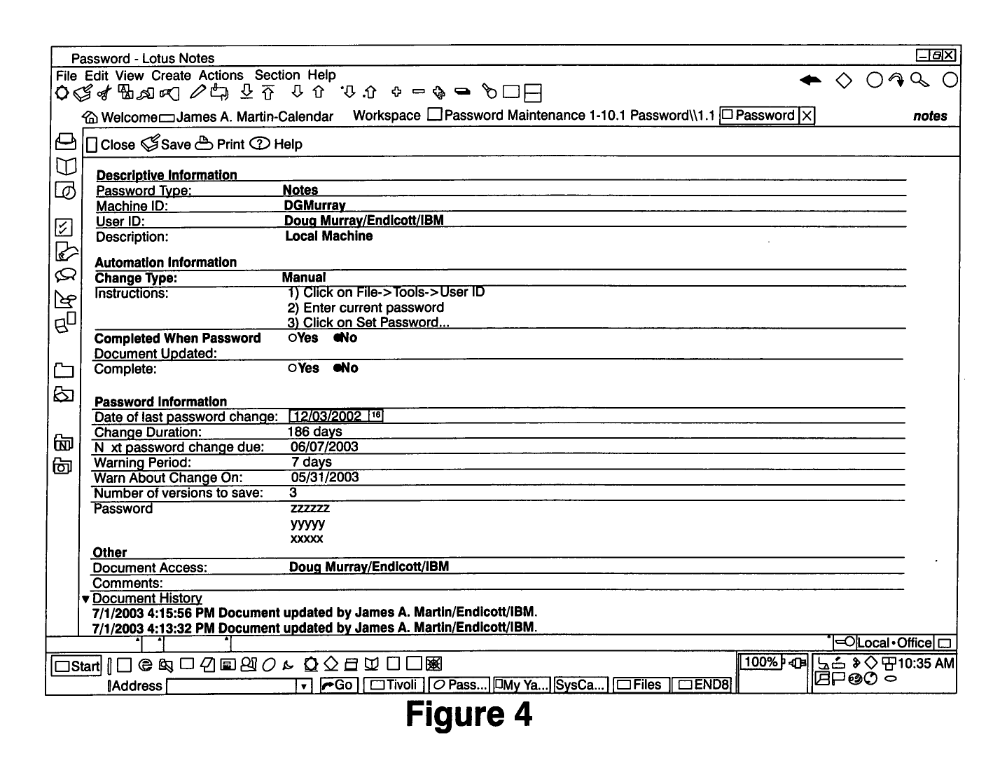

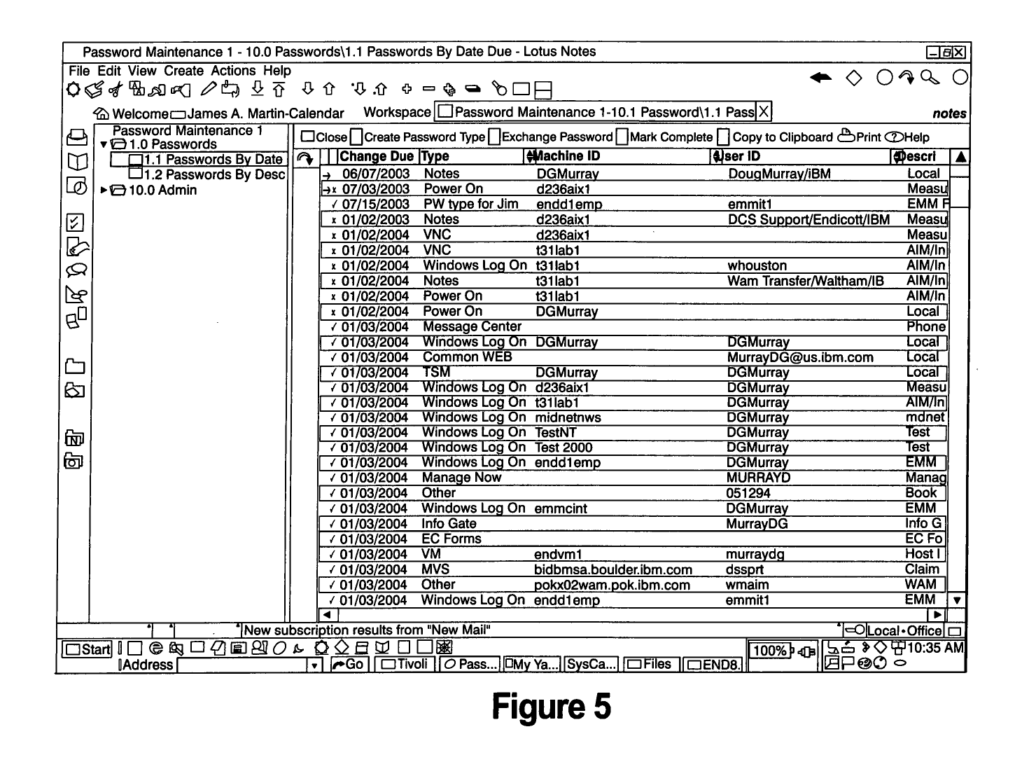

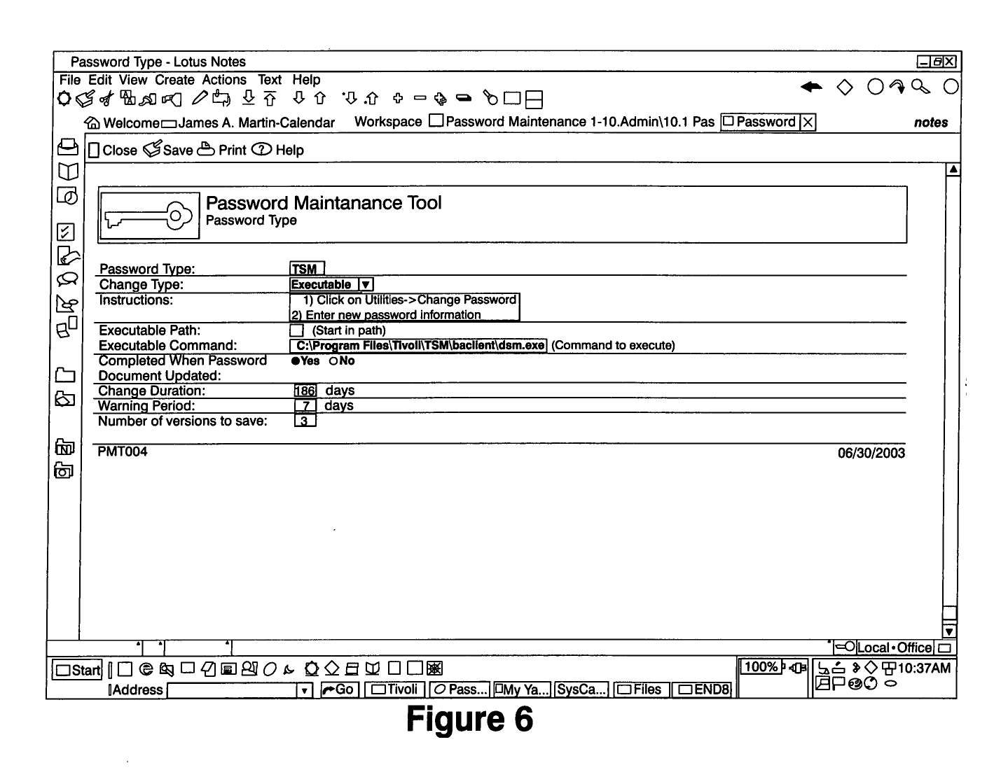

FIGS. 3-6 show several screens that may be displayed in the implementation of this invention. More specifically, FIG. 3 shows a working view into the password database. Each entry in the list shown in this screen represents a password document. FIG. 4 illustrates a password document that defines a password and associated descriptive information. FIG. 5 is a view of classes or types of passwords, and this view is used to create a new password. FIG. 6 shows a password type definition document that describes a type of password and provides associated information.

As indicated above, preferably scripts are used to effect the password changes. Scripts are routines implemented in a scripting programming language such as PL/SQL, and scripts provide the functionality available in routines implemented in other standard languages. Script text represents computer instructions, and some of the text can embody criteria for passwords.

The use of scripts facilitates the extension of the security and password mechanisms. The criteria that proposed passwords must meet can be expanded. For example, a script can embody criteria that require that the proposed password differ by the old password by a given number of characters. A script can also embody complexity criteria, such as requiring that a proposed password must contain a number of alphabetic characters, a number of numeric characters, and a number of punctuation characters. Because a script can operate on data from a table, security mechanisms can be expanded to include additional criteria based on data from, for example, user tables, user profile table, and user history tables.

The scripts can also embody other criteria based on data from other tables or databases. As an illustration, a criterion could be that users that connect to a database after a certain time belong to a certain class of employees. Based on the user ID, the script could query an employee table in another database to determine the class of the employee associated with the user ID.

Appendix A lists source code that may be used to implement the present invention.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A tool for maintaining passwords, comprising:
storage for a plurality of current passwords for a plurality of respective applications;
means for displaying a reminder to change one or more of said passwords; and
a script for simulating keystroke entries, or running an executable program, to automatically perform a password change in said respective applications for said current passwords of said reminder.

2. A tool according to claim 1, wherein the applications are selected from the group including workstation applications, legacy host applications, server applications, and networked applications.

3. A tool according to claim 1, wherein the means for displaying includes:
means for displaying a list of passwords; and
means for displaying a graphical user interface for invoking the script to change the passwords.

4. A tool according to claim 3, wherein the graphical user interface includes a series of activatable display elements, each display element being shown adjacent one of the passwords to invoke script for changing said one password.

5. A tool according to claim 1, wherein at least some of the applications include a password change form and require a series of actions to get to the password change form, and the script includes means to perform said series of actions to get to the password change form.

6. A tool according to claim 1, wherein the passwords are encrypted in said storage.

7. A method for managing passwords to computer applications, comprising the steps:
accumulating a set of passwords in a password management facility, each of said passwords being associated with a computer application having a password change procedure; and
providing the password management facility with a set of scripts to operate the password change procedures of the associated applications; and
invoking the scripts to change the passwords.

8. A method according to claim 7, wherein the step of invoking the scripts includes the steps of:
accessing the password management facility;
said password management facility displaying a list of passwords and a graphical user interface for invoking the scripts; and
using said graphical user interface to activate the scripts to change the passwords.

9. A method according to claim 7, wherein:
the displaying step includes the step of displaying a plurality of activatable display elements, each of said elements being displayed adjacent one of the passwords on the list; and
the using step includes the step of activating one of the display elements, said one of the display elements being adjacent one of the passwords, to change the password for the application associated with said one of the passwords.

10. A method according to claim 7, wherein each of the scripts simulates a set of keystroke entries or an executable program to change the password for one of the applications.

11. A method according to claim 7, wherein the applications are selected from the group including workstation applications, legacy host applications, server applications, and networked applications.

12. A method according to claim 7, wherein the step of accumulating the passwords includes the step of storing the passwords in an encrypted form in the password management facility.

13. A program storage device readable by machine, tangibly embodying a program of instructions executable by the machine to perform method steps for managing passwords to computer applications, said method steps comprising:
accumulating a set of passwords in a password management facility, each of said passwords being associated with a computer application having a password change procedure; and
providing the password management facility with a set of scripts to operate the password change procedures of the associated applications: and
invoking the scripts to change the passwords.

14. A program storage device according to claim 13, wherein the step of invoking the scripts includes the steps of:
accessing the password management facility;
said password management facility displaying a list of passwords and a graphical user interface for invoking the scripts; and
using said graphical user interface to activate the scripts to change the passwords.

15. A program storage device according to claim 13, wherein:
the displaying step includes the step of displaying a plurality of activatable display elements, each of said elements being displayed adjacent one of the passwords on the list; and
the using step includes the step of activating one of the display elements, said one of the display elements being adjacent one of the passwords, to change the password for the application associated with said one of the passwords.

16. A program storage device according to claim 13, wherein each of the scripts simulates a set of keystroke entries or runs an executable program to change the password for one of the applications.

17. A program storage device according to claim 13, wherein the applications are selected from the group including workstation applications, legacy host applications, server applications, and networked applications.

18. A program storage device according to claim 13, wherein the step of accumulating the passwords includes the step of storing the passwords in an encrypted form in the password management facility.
